(19) United States
(12) Patent Application Publication
(10) Pub. No.: US 2009/0249028 A1
(43) Pub. Date: Oct. 1, 2009

(54) PROCESSOR WITH INTERNAL RASTER OF EXECUTION UNITS

(76) Inventor: Sascha Uhrig, Augsburg (DE)

Correspondence Address: VENABLE LLP, P.O. BOX 34385, WASHINGTON, DC, 20043-9998, US

(21) Appl. No.: 12/304,655

(22) PCT Filed: Jun. 12, 2007
(86) PCT No.: PCT/DE2007/001022

§ 371 Date: Dec. 12, 2008

(30) Foreign Application Priority Data
Jun. 12, 2006 (DE) 10 2006 027 181.5

(51) Int. Cl. G06F 15/80; G06F 9/06

(52) U.S. Cl. 712/15; 712/E09.003; 712/16

(57) ABSTRACT

The present invention relates to a processor that, as its main feature, has an internal raster of ALUs, with the help of which sequential programs are executed. The connections between the ALUs are automatically created at runtime dynamically by means of multiplexers. A central decoding and configuration unit that creates configuration data for the ALU grid from a stream of conventional assembler commands at runtime is responsible for creating the connections. In addition to the ALU grid, a special unit for the execution of memory accesses and another unit for the processing of branch instructions are provided. The novel architecture that is the foundation of the processor makes efficient execution of both control flow- and data flow-oriented tasks possible.

### TECHNICAL FIELD/STATE OF THE ART

The present invention pertains to a processor for executing sequential programs. Processes of this type operate with a sequence of commands that are processed sequentially. The commands are individually decoded and subsequently executed in so-called execution units. In conventional processors such as, e.g., superscalar processors or VLIW-processors, the execution units are arranged one-dimensionally. Consequently, only commands that are not interdependent at all can be assigned to these execution units in one cycle. Dependent commands can only be assigned and therefore executed in the next cycle after the execution of the aforementioned independent commands.

In so-called “tiled architectures,” a conventional processor is connected to array structures of reconfigurable systems. In this case, the array structures typically comprise a two-dimensional arrangement of small processes for executing the commands. In many instances, another control processor is provided outside the array in order to centrally control the small processors. The data paths between the small processors usually can be controlled autonomously by these processors such that a data exchange can take place between the processors. The programming of these “tiled architectures” takes place in the form of several sequential command streams that can be assigned to the individual processors.

In this case, the control processor generally operates with a separate command stream, if applicable even with a different command set than the array processors.

In addition to the aforementioned processors and processor architectures, there also exist so-called reconfigurable systems that consist of a more or less homogenous central, usually two-dimensional arrangement of task elements. However, these systems do not consist of processors, but rather of systems that are used in addition to processors. During a configuration phase, a task is assigned to the task elements that are more and less specialized. The task elements are connected to one another and can exchange data via data paths. These data paths usually are already set or programmed during the configuration phase. In reconfigurable systems, the configuration data already is explicitly compiled beforehand, i.e., during the programming of the complete system. In practical applications, this is realized manually with the aid of suitable synthesis tools. A special mechanism loads the configuration data all at once into the reconfigurable system from a memory at runtime, wherein the data remains in the reconfigurable system as long as this configuration is required. Reconfigurable systems usually operate parallel to a conventional processor, the program of which is kept separate of the configuration data.

The present invention is based on the objective of making available a processor that can be efficiently used in control flow-oriented and in data flow-oriented applications and the performance of which is superior to that of known processors with respect to the execution of control flow-oriented programs.

### DISCLOSURE OF THE INVENTION

This objective is attained with the processor according to claim 1. Advantageous embodiments of the processor form the objects of the dependent claims or can be gathered from the following description and the embodiments.

The present processor comprises a two-dimensional arrangement of several rows of configurable execution units that can be arranged in columns and connected into several chains of execution units by means of configurable data connections from row to row. The arrangement features a feedback network that makes it possible to transfer a data value that is output at the data output of the bottom execution unit of each chain to a top register of the chain. In this case, the execution units are designed in such a way that they treat, i.e., process or pass through, data present at their data input in accordance with their instantaneous configuration during one or more execution phases and make available the processed data for the ensuing execution unit in the chain at their data output. During several decoding phases that are separated by one or more execution phases, a decoding and configuration unit provided as front end autonomously selects execution units from an individual incoming sequential command stream at runtime, generates configuration data for the selected execution units and configures the selected execution units for the execution of the commands via a configuration network. The decoding and configuration unit may also be composed of a decoding unit and a separate configuration unit in this case. The processor furthermore features a skip control unit for processing skip commands that is connected to the execution unit via data lines, as well as one or more memory access units for executing memory accesses that is/are connected to the execution units via data lines.

The central component of the processor architecture, on which the proposed processor is based, is a two-dimensional structure of simple task elements, namely execution units that do not feature separate processors. The execution units are usually realized in the form of arithmetic-logic units (ALUs) that form a grid of rows and columns referred to as an ALU-grid below in one embodiment of the processor. Due to their preferred design, the execution units are simply referred to as ALUs below, however, without restricting these embodiments to ALUs only. In the aforementioned design with an internal grid of ALUs, each column represents an architecture register. Consequently, the number of columns is exactly as high as the number of architecture registers of the basic processor architecture in this case, i.e., it is dependent on the selected assembler command set. However, this is not necessary in all instances as described in greater detail below. The number of rows is dependent on the available chip surface. The higher the number of rows, the better the anticipated performance. For example, a range between five and ten rows may be sensible for the application in a desktop PC.

The decoding and configuration unit individually assigns a certain function to the ALUs in a dynamic fashion via a configuration network. This programming of the ALUs takes place in a clock-synchronized fashion. Once programmed, the ALUs operate asynchronous to the respective values present at their data inputs, i.e., they feature no storage elements at all for the task data. The task data or a portion thereof can also be assigned a specified fixed value during the configuration.

A data exchange can take place between the ALUs, wherein this data exchange is, however, always directed from the top to the bottom of the column or chain and supplies the ALUs with task data. A row of registers that is referred to as top-register in the present patent application is arranged above the top row. Additional register rows may be optionally arranged between other rows. However, these intermediate registers need to feature a bypass technology such that arriving data can be stored or directly looped through.

In the following description of the processor and of preferred embodiments of the processor, only the term column is used for reasons of simplicity. Naturally, all explanations apply analogously to a connection of the ALUs into chains that do not extend linearly.

In addition to the data paths that lead through the ALUs (in the forward direction) and form a so-called feedforward network, separate data feedbacks are provided that feed data present at the end of a column to the beginning of the same column, i.e., into the top-registers. These data feedbacks form a so-called feedback network. Optionally, the data feedbacks may also feed data from a different location within a column, e.g., the intermediate registers, back to a location of the column that lies further toward the top, e.g., into another row of intermediate registers.

In addition to the central ALU-grid, one or more memory access units and a skip control unit are provided. Under certain conditions, the skip control unit initiates the feedback of data from the bottom toward the top via the data feedbacks. The memory access units make it possible to execute memory accesses in order to transport data from the ALU-grid into the memory or data from the memory into the ALU-grid, respectively. In this case, a certain number of memory access units is preferably assigned to each row of the ALU-grid.

Each ALU preferably features a special predication input that makes it possible to deactivate the corresponding ALU during the task. If an ALU is deactivated, it forwards the value present at the top, i.e., at its data input, to its data output in unchanged form. The predication inputs are operated by the skip control unit. This makes it possible to map so-called “predicated instructions” of the assembler command set on the ALU-grid, i.e., it is possible to execute certain commands under certain conditions only.

Consequently, the main characteristic of the novel processor architecture, on which the processor is based, consists of an internal two-dimensional arrangement or a grid of execution units or ALUs that make it possible to execute sequential programs. The connections between the ALUs are automatically produced at runtime in a dynamic fashion by means of multiplexers. A central decoding and configuration unit (front end) that generates configuration data for the ALU-grid at runtime from a stream of conventional or slightly modified commands is responsible for producing the connections. This novel architecture and the proposed processor represent a middle ground between conventional processors and reconfigurable hardware. The former are better suited for control flow-oriented tasks, e.g., control tasks, while the strength of reconfigurable hardware lies in the solution of data flow-oriented problems, e.g., in video and audio processing. A standard architecture that is equally suitable for both types of problems was not known until now. The proposed architecture makes it possible to process data flow-oriented tasks, as well as control flow-oriented tasks, with a conventional programming language, e.g., C/C++. Depending on the respective requirements, the advantages of processors or of reconfigurable hardware are then achieved during the execution of the program code.

Depending on the expansion stage, the new processor is suitable for use in all types of data processing systems. In one powerful variation, the processor or the basic architecture can be used in database servers or computer servers. In a reduced expansion stage, it would also be possible to consider the utilization in mobile devices. Since the architecture is completely scalable in one direction, software that was developed for an expansion stage can also be executed on another expansion stage. Consequently, compatibility in both directions (forward and backward) is achieved.

The fundamental idea with respect to the present processor architecture or the present processor consists of dynamically mapping the individual machine commands of a sequential command stream on a reconfigurable multiline grid of ALUs and to thusly execute a conventional program. In addition to the option of an efficient utilization in control flow-oriented and data flow-oriented fields of application, this technique also results in a performance that is superior to that of conventional processors during the execution of purely control flow-oriented programs.

In contrast to known processor architectures, it is therefore possible to assign dependent commands to the execution units in the same cycle and, if applicable, to also execute said commands in one cycle. Due to the skip prediction that is initially not provided, no “misprediction-penalty” occurs during incorrectly predicted skips. However, the proposed architecture still allows the efficient treatment of skips that manifests its full efficiency during the execution of loops. In this case, the decoding and the assignment of new commands into the ALU-grid are eliminated and only commands that already exist in the ALU-grid are executed. A loop is assigned once in the ALU-grid after it was identified as such and remains in the ALU-grid until the program once again exits this loop. The decoding and assignment unit therefore can be deactivated during this time. In conventional processors, in contrast, each command needs to be assigned to an execution unit once per pass through the loop during the execution of loops. Consequently, the assignment unit and, during errors of a “trace-cache,” the decoding unit are continuously activated in such processors. In contrast to similarly designed “tiled architectures,” no special compilers or other software development tools are required for the presently proposed architecture. In contrast to simple reconfigurable systems, the programming of the ALU-grid takes place with a sequential command stream that directly originates from the compiler and is realized in the form of conventional assembler commands. The execution units of the ALU-grid are configured with these commands and usually maintain this configuration for a very short time only unless a loop is currently executed. The configuration of the entire ALU-grid therefore results dynamically from the sequence of processed commands and not from statically generated configuration data.

### BRIEF DESCRIPTION OF THE DRAWINGS

The present processor and the basic processor architecture are once again described in greater detail below with reference to embodiments that are illustrated in the drawings. In these drawings:

FIG. 1 shows a block diagram of one possible embodiment of the proposed processor;

FIG. 2 shows an exemplary design of an ALU;

FIG. 3 shows an exemplary design when using synchronous data flow tokens;

FIG. 4 shows an example of a first assignment of an exemplary program to the ALUs;

FIG. 5 shows an example of a second assignment of an exemplary program to the ALUs;

FIG. 6 shows an example of the integration of complex execution units into the ALU-grid, and

FIG. 7 shows another example of an assignment of the exemplary program to the ALUs in a pipeline variation.

### WAYS FOR REALIZING THE INVENTION

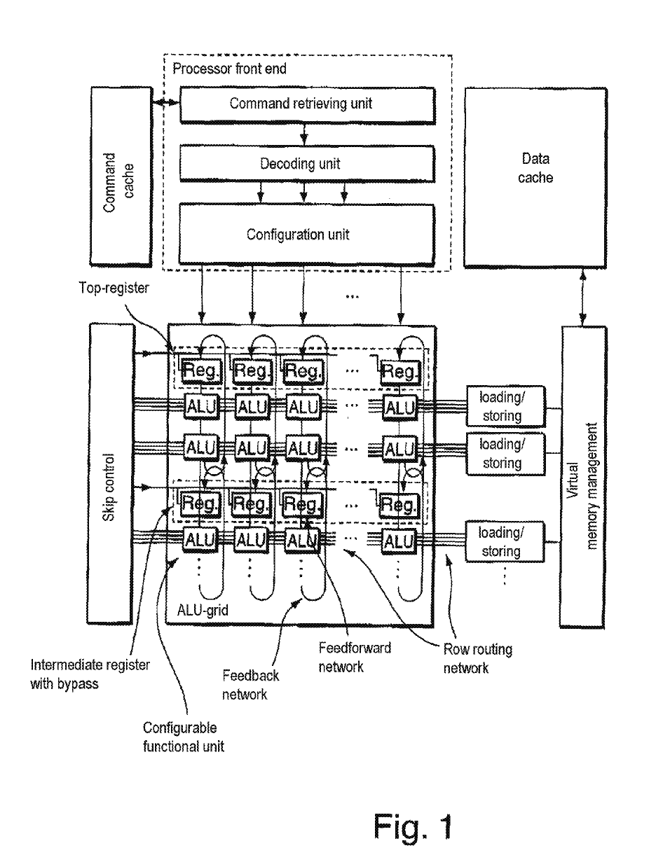

FIG. 1 shows an example of one possible embodiment of the processor in the form of a block diagram. In this block diagram, the ALU-grid forms the central component of the processor. A command retrieving unit, a decoding unit and a configuration unit form the front end. The command cache, the data cache and the virtual memory management unit are also shown in this figure and consist of standard components.

In this example, the ALUs are arranged row-by-row and column-by-column, wherein a corresponding top-register is provided at the input of each column. Intermediate registers with a bypass are also indicated in this figure between individual rows of ALUs. The ALUs are connected to a skip control unit and to several memory access units (loading/storing) via a row-routing-network. The configuration network and the predication network are not illustrated in this block diagram.

FIG. 2 shows an exemplary design of an ALU that can be used in the present processor. The configuration data is written into a configuration register of the ALU by the configuration unit and the configuration clock cycle is transmitted, namely via the synchronous inputs. The ALU receives the task data from the top-register or the preceding ALU in the column via the asynchronous data inputs A and B. The ALU may also operate with a fixed value specified during the configuration instead of the task data at the data input B. If so required, the ALU also can simply loop through the data if one of the not-shown multiplexers (MUX) is configured accordingly. FIG. 2 also shows the predication input that makes it possible to deactivate each ALU during the task by means of the skip control unit.

The program execution with the proposed processor is based on a sequential stream of assembler commands, e.g., RISC-assembler commands. These commands are loaded into the processor from the memory packet-by-packet (one or more commands) by a command retrieving unit and transferred to the decoding unit. This decoding unit checks for dependencies on preceding commands and forwards the current commands to the configuration unit together with the dependency information. The configuration unit has the function of selecting an ALU for each command, to assign the corresponding functionality to this ALU and to correctly configure the multiplexers for the task data. If the command consists of a skip command or a memory access command, special measures are taken that are described in greater detail below.

The function of the processor is divided into two parts, namely the command arrangement of the individual assembler commands in the ALU-grid (decoding phase) and the actual execution of the commands within the grid, as well as the skip control unit and the memory access unit (execution phase). Although these two parts are discussed separately below, these processes may be partially executed in the processor with a time overlap.

During the command arrangement, parts of the sequential program are, in principle, always transferred into the ALU-grid. In this respect, one must distinguish between the three following groups of commands:
Memory access commands: these include all commands that require a data access to the external memory, e.g., load, store, push, pop. If applicable, an address calculation is arranged in the ALU-grid for these commands; the actual memory access is realized by one of the memory access units.
Skip commands: in this respect, one needs to once again distinguish between conditional and unconditional skips. If they do not use indirect addressing, unconditional skips are directly processed in the decoding unit and are not relevant to the ALU-grid. Conditional and indirect skips are forwarded to the skip control unit. This unit processes the values received from the ALU-grid and, if so required, initiates an actual skip in the program code, i.e., new commands of the program are arranged in the ALU-grid. If no new commands are loaded, control signals for the ALU-grid are generated such that it continues to operate in accordance with the desired program sequence (e.g., during the return within a loop). For this purpose, the data feedbacks within the ALU-grid are used for sending the calculated results from the end of the grid to the top-registers or the corresponding intermediate registers within the grid.
Arithmetic-logic commands: these include all remaining commands. These commands are respectively assigned to an ALU in the grid, i.e., one selected ALU is configured such that it executes the function of the corresponding command.

With respect to the arrangement of the arithmetic-logic commands in the ALU-grid, the column and the row in the grid need to be determined individually for each operation. This is realized in accordance with the following procedure:
Selection of the column: the column in which the command should be executed is determined by the destination register of the command. After the operation, the output of the selected ALU assumes the calculated value and forwards this value downward for further operations via a feedforward network, i.e., the data connections between the ALUs in the column direction. The feedforward network of the selected column therefore sectionally carries the values that the corresponding architecture register would assume between the calculations.
Selection of the row: the row in which the operation needs to be executed is determined based on the lowest point, i.e., the most progressed calculations, of all registers participating in the operation. This means that the new operation needs to be arranged below the last operation of the destination register column. Furthermore, all operations of the source register or source registers that were already assigned also need to lie above the new ALU to be selected.

After the selection of the ALU to be newly configured, the multiplexers of the horizontal network (row-routing-network) need to be switched in such a way that the data of the source registers is present at the new ALU. It also needs to be ensured that the values of the source registers are routed to the desired row in unchanged form. If applicable, this requires the deactivation of ALUs in the columns of the source register if no data paths in the forward direction other than the ALUs are provided. The selected ALU is configured in such a way that it executes the operation of the current command. The data flow graph of the arranged arithmetic-logic assembler commands is built up within the ALU-grid due to this procedure.

In contrast to the arithmetic-logic commands, memory access commands are stored outside the ALU-grid in one of the memory access units. Only the selection of the row is important in this respect. This row is selected equivalent to the arithmetic-logic commands, i.e., depending on the source registers (for the memory address and, if applicable, for the write data) used. A possibly required address calculation (e.g., addition of two registers or addition of an offset) is arranged in the ALU-grid equivalent to the arithmetic-logic commands.

Skip commands fulfill their function under the control of the skip control unit. Data lines also lead from the ALU-grid into the skip control unit row-by-row. Depending on the skip command to be executed, this skip control unit checks the data lines and, if applicable, generates corresponding control signals for the processor front end, as well as the ALU-grid. If the decoding unit or the configuration unit detects forward skips over a short distance (a few commands), the skip commands may, in principle, be arranged in the ALU-grid. The skip control unit controls the actual execution of the corresponding commands via the predication network during the execution phase.

After a sufficient number of commands were arranged in the ALU-grid and the laterally adjacent units, the decoding of new commands is stopped and the command execution phase begins.

The initial values of all architecture registers are stored in the top-registers. The values immediately migrate into the previously selected ALUs via the feedforward network. The desired operations are executed in the ALUs. If a memory access command needs to be executed, the required address and, if applicable, the write data are captured and a synchronous memory access is executed. After a read access, the read data is routed into the ALU-grid and additionally processed.

If a skip command needs to be executed, the data words relevant to the skip command are evaluated in the skip control unit (i.e., data is, if applicable, compared and the skip destination is calculated) and one of the following operations is carried out:
The skip destination was not yet integrated into the ALU-grid: all data present underneath the skip command in the feedforward network is copied into the top-register of the respective column. Subsequently, a reset of the ALU-grid is carried out, i.e., all functions of the ALUs are deleted and the connections are terminated. All memory access units and the skip control unit are also reset. Subsequently, the front end of the processor is reactivated and new commands from the desired location of the program code are arranged in the ALU-grid.
The skip destination already exists in the ALU-grid: in this case, only the data underneath the skip command is copied into the registers (top or intermediate registers) above the location in the grid, at which the skip destination is arranged in the grid. This is followed by another command execution phase.

If no skip command had to be executed during the execution phase, all data is copied from the lower end of the ALU-grid into the top-registers after the end of the execution; they now represent the new initial values for the next execution phase to follow. Subsequently, a new decoding phase starts.

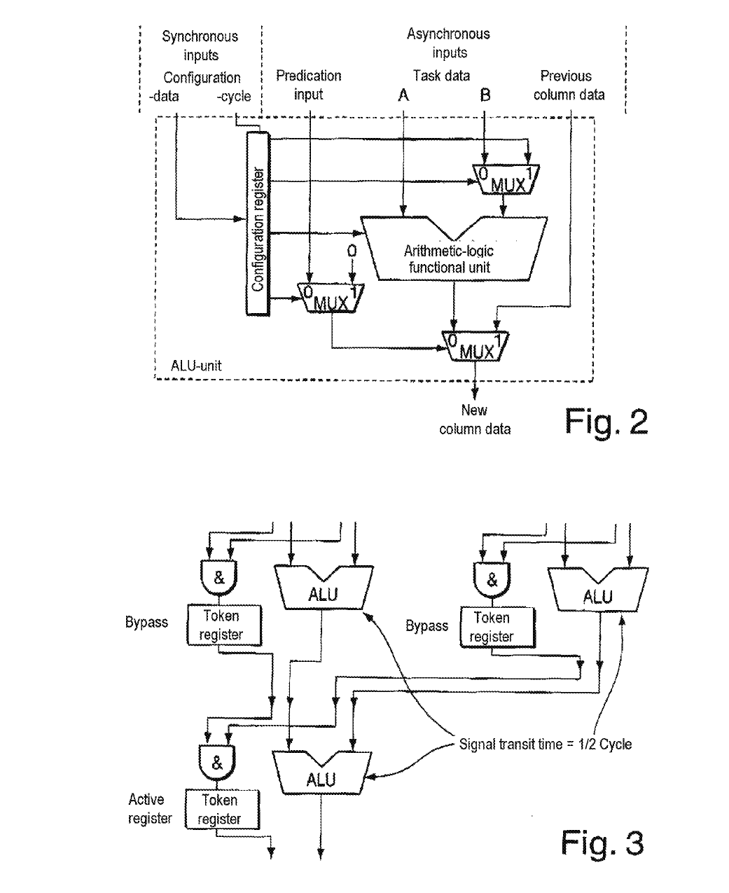

Since the execution of the individual operations in the ALUs takes place asynchronously, it is not possible to determine the end of an execution phase or the time, at which a memory access or a skip can take place, without other auxiliary means. In this respect, one can choose between three different techniques:
Tokens using delay elements: a delay element assigned to each ALU contains a corresponding delay value during the configuration of the ALU. This delay value needs to correspond to the maximum signal transit time of the desired operation of the ALU. Likewise, the data lines contain another bit (token) that is looped through the delay elements. If the tokens of all required operations arrive in an ALU, a token is generated at the output of the ALU with a delay that corresponds to the respective maximum signal transit time.
Transit time counter: during the assignment of the functions to the ALUs, the signal transit times of all columns are counted (in the form of so-called pico cycles, i.e., in fractions of the machine cycle). The times relevant to synchronous operations are stored in the respective units. The desired operations are then initiated at the respective times, i.e., each synchronous unit waits until the required data is available according to the transit time counter.
Synchronous tokens: tokens are also used in this case. However, the transfer of the tokens is not realized with asynchronous delay elements at each ALU, but rather registers with a bypass at each ALU. The register is deactivated by default, i.e., the bypass is active. Analogous to the previous variation, the signal transit time of the data is counted during the configuration of the ALUs. If the counted signal transit time becomes greater than one cycle, the token-register of the currently configured ALU is activated and the transit time counter is decremented by one cycle. In this technique, the token does not run through the data flow graph synchronous to the data, but rather leads by no more than one cycle. This needs to be taken into consideration in the execution of synchronous operations. FIG. 3 shows an example, in which all three ALUs execute operations that have a signal transit time of half a machine cycle. The token-registers of the two upper ALUs are switched to bypass while the token-register of the lower ALU delays the token until the data is actually available.

With respect to the function of the ALU-grid, only one of the three described synchronization options needs to be realized. The last variation is preferred due to its flexibility.

In the following example, a program is specified in an assembler code and mapped on an ALU-grid processor without intermediate registers. The function of the program consists of forming the sum of the amounts of a numerical vector with a length of 15 elements. In this case, the vector already needs to be present in the main memory connected to the ALU-grid processor. The program is executed in several decoding and execution phases. Likewise, several command retrieving cycles are required for each decoding phase, but summarized in this description.

| move R1, #15 | ;15 data values |
|---|---|
| move R2, #address | ;starting address of |
| | ;the vector |
| move R0, #0 | ;set register for the |

;sum to 0

loop:

| load R3, [R2] | ;read one element out |
|---|---|
| | ;of the memory |
| jmpnl R3, not_negative | ;is this not;negative? |
| neg R3 | ;if negative: negate |

not_negative:

| add R0, R3 | ;add absolute value |
|---|---|
| | ;to sum register (R0) |
| add R2, #4 | ;increase address |
| | ;for next element |
| sub R1, #1 | ;one data element was |
| | ;processed |
| jmpnz R1, loop | ;still more data values? |

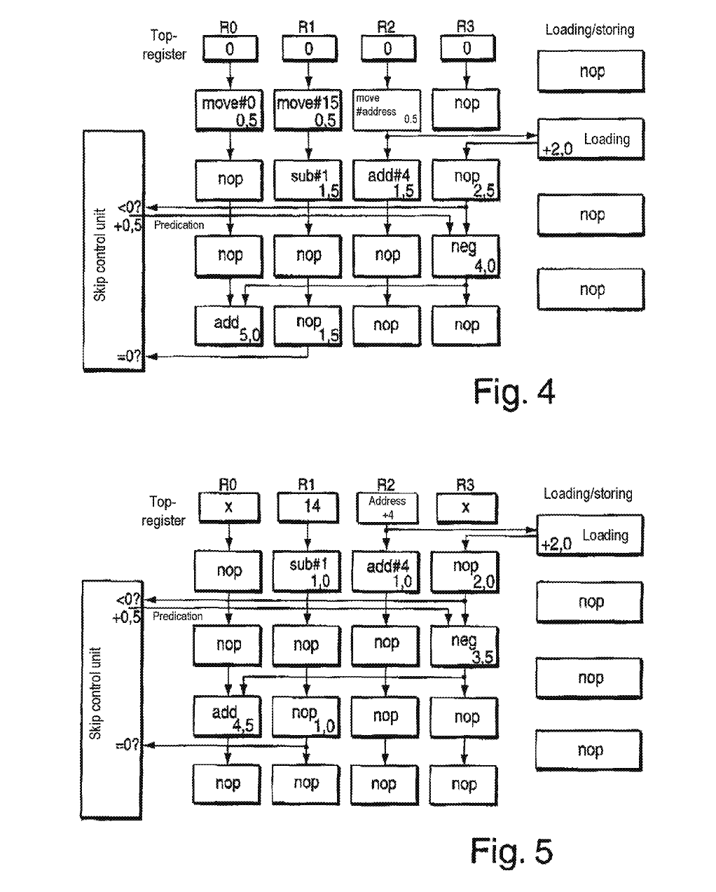

The execution of this program segment takes place in two decoding phases and in a total of 15 execution phases. In the first decoding phase, all commands of the program are arranged in the ALU-grid. During this process, the decoding unit detects that the first skip command only skips a single arithmetic-logic command. This one command is arranged in the ALU-grid like any other arithmetic-logic command, but the predication line of the corresponding ALU is connected to the skip control unit. The skip control unit is configured in such a way that it checks the value of R3 for a negative sign at the appropriate time. The assignments of the ALUs, the skip control unit and the memory access units are illustrated in FIG. 4, in which only the registers or columns R0 to R3 are schematically illustrated. In this case, it was assumed that the commands add, sub and neg respectively require one full machine cycle for their execution and the move-commands require half a machine cycle for their execution. Two cycles are assessed for a cache access and each of the two comparative operations in the skip control unit requires half a cycle. These times are merely chosen as examples and need to be precisely determined during the actual implementation.

The numerical values in FIG. 4 indicate the time, at which the corresponding value becomes valid, in machine cycles. Depending on the method used for the synchronization, a central time counter needs to be provided that counts the time elapsed since the beginning of the calculation. If a memory access generates a cache-miss, this counter is stopped until the desired datum was loaded from the memory. A time counter is not required if tokens are used. This results in a much more flexible runtime behavior.

At the time 2,5 machine cycles, the first value of the vector is read out of the memory and the skip control checks this value for a negative sign. If the read value in R3 is negative, the neg-command is executed, wherein the corresponding ALU is otherwise deactivated by means of the predication signal and the input value is forwarded to the output in unchanged form.

At the time 5 machine cycles, the execution of all mapped commands is completed and the result of the last comparative operation can be observed. In this case, the value in the column R1 is 14, i.e., not 0, and a skip is executed. The skip control unit registers that the skip destination was not mapped on a row with registers (top or intermediate registers). Consequently, all values at the lower end of the ALU-grid are copied into the top-register. Subsequently, all ALU-configurations are reset and another decoding phase is started at the location of the skip destination in the program code. After the completion of this decoding phase, the first command of the loop element is situated in the first row, i.e., directly underneath the top-registers. The ALU-grid is now configured as shown in FIG. 5.

After the second execution phase (4,5 cycles after its beginning), the register R1 that now has the value 13 is once again checked for the value zero. Consequently, the skip is recognized as “to be executed” and it is once again checked if the skip destination is already situated at the appropriate location in the ALU-grid. This time, the skip destination corresponds to the first command in the ALU-grid, i.e., no new decoding phase is started, but only the values at the lower end of the ALU-grid are copied into the top-registers. Subsequently, another execution phase is started.

Once the register R1 reaches the value 0, the skip at the end of the loop is evaluated as “not to be executed.” This causes the initiation of a new decoding phase. In this case, the ALU-grid receives additional commands (that are not indicated in the example) until the capacity of the ALU-grid is reached or another skip command appears in the program code.

The first of the above-described execution phases reaches an IPC (Instructions Per Cycle) of 2 (10 commands in 5 cycles) and the second execution phase reaches an IPC of 1.4 (7 commands in 5 cycles). In this case, 2 cycles are respectively allotted to the memory access alone. A conventional (superscalar) processor presumably would deliver much inferior results. One also needs to take into account that the ALU-grid processor operates without skip prediction. This skip prediction can cause significant performance losses in superscalar processors if incorrect predictions are made. In addition, the lack of a skip prediction leads to a predictable runtime behavior of the ALU-grid processor.

In the previous example, it is obvious that only a very small percentage of the capacity of the ALU-grid is used. The number of ALUs can be reduced if the architecture registers are not directly mapped on the columns of the grid, but only a few ALUs that can be used by all register columns are integrated per row. Likewise, the ALUs can be specialized such that not all ALUs need to be realized in the form of complex multi-function ALUs. In this case, a register renaming of sorts could possibly be utilized, i.e., the column is not assigned to a register in a fixed fashion, but the assignment changes from row to row.

The previous example also shows that the decoding and configuration unit was not needed for a very long time (13 of 15 loop passes). The integration of a suitable energy saving mechanism can be realized in this case, e.g., in the form of dynamically switching off the unit(s). This applies analogously to unneeded ALU-rows underneath the ALU that was needed last. Since the described architecture is freely scalable with respect to the number of rows, it is possible to realize a minimal implementation with two rows for use in mobile (micro) systems or to switch off rows in a context-controlled fashion (e.g., few active rows in the battery mode and many active rows in the mains-operated mode of notebooks).

Since each of the memory access units can only be assigned to one load/store command, it is advantageous to implement efficient streaming buffers directly into each memory access unit. The simple loading of a complete cache row directly into a memory access unit can already provide enormous performance advantages in this case. The memory access units can also process the existing data asynchronously, wherein this would shorten the runtime of a loop pass by 1-1.5 cycles in the previous example.

This also demonstrates the disadvantages of the time counter method for the synchronization: first, the “time” needs to be completely stopped if a cache-miss occurs, i.e., calculations that could take place simultaneously with the main memory access cannot manifest their advantages. Second, the worst-case scenario always needs to be expected in the time counter method, i.e., it must always be expected that all assigned commands actually need to be executed. In the described example, all loop passes require the same time regardless of the fact whether or not the negation needs to be executed. Both of these problems do not arise in the two token-methods.

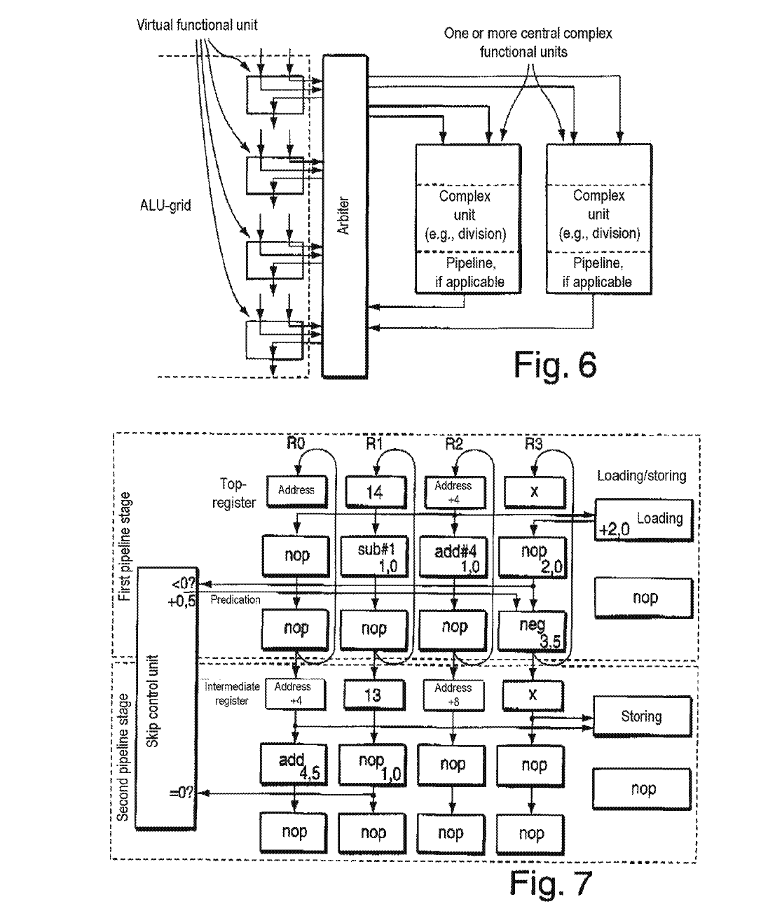

It is not sensible (and sometimes not even possible) to directly integrate complex functions such as divisions or floating-point calculations into the asynchronous ALUs. When using a technique, in which few ALUs per row can be used in all columns as described above, it would also be possible to utilize special execution units that can only execute one task (e.g., division). In this case, however, it is not sensible to realize a separate division unit per row. On the contrary, it would be possible to implement so-called virtual units in each row (see FIG. 6). Only all required connections (inputs and outputs) are realized in each row by means of virtual units. If all tokens are present in one row, i.e., if the task data is available, a corresponding calculation can be carried out by a central (now clocked) special execution unit that is connected to the virtual unit. In this case, the calculation can also be carried out in a pipelined fashion such that several of these calculations can take place with a time overlap. This expansion can only be sensibly integrated if one of the two token-based synchronization methods is used.

A method for the optimized processing of loops, namely so-called software-pipelining, is known from the compiler technology. In this case, the program code of a loop element is realized such that calculations for the next iteration are already carried out when an iteration is processed. Registers other than those actually required are used for this purpose in most instances and the results are copied into the relevant registers at the appropriate time.

If the realized ALU-grid processor is equipped with intermediate registers, it would be possible to utilize a different type of pipelining: true hardware pipelining. The intermediate registers can be used as pipeline registers in this case. However, this technique only works if the result of the critical path of an iteration is not required for the next iteration. In order to implement pipelining on the ALU-grid processor, it is either necessary to expand the command set or to expand the decoding unit. In both instances, the configuration unit needs to be notified which registers represent the unneeded critical path and that pipelining is possible in this case.

This is elucidated with the following example: if the above-described exemplary program would not sum up the vector, but merely write back the value of each element into the memory, the critical path (in the example R0) of an iteration would not be relevant to the next iteration. The modified program code of the example is shown below. FIG. 7 shows one possible assignment (beginning with the second iteration) of the commands for the embodiment in the form of a pipeline. An additional command for the pipelining was not taken into consideration in this case.

| | |
|---|---|
| move R1, #15 | ;15 data values |
| move R2, #address | ;starting address of |

;the vector

loop:

| load R3, [R2] | ;read one element out |
|---|---|
| | ;of the memory |
| jmpnl R3, not_negative | ;is this not;negative? |
| neg R3 | ;if negative: negate |

not_negative:

| move R0, R2 | ;intermediately store |
|---|---|
| | ;address for STORE |
| add R2, #4 | ;increase address |
| | ;for next element |
| store [R0], R3 | ;rewrite absolute |
| | ;value into memory |
| sub R1, #1 | ;one data element was |
| | ;processed |
| jmpnz R1, loop | ;still more data values? |

In the pipeline-variation, it needs to be taken into consideration that the data feedback into the top-registers needs to take place from the intermediate registers rather than from the end of the grid. However, the decision on the loop end still needs to be reached after the last pipeline stage. If the upper portion of an iteration was already carried out although the loop condition is no longer fulfilled, no additional measures with respect to the registers are necessary. Since the additional processing only continues with the values at the end of the grid, all intermediate results in the intermediate registers are automatically discarded. However, if write accesses to the main memory take place in stages other than the last pipeline stage, they need to be suppressed until it is clear if the respective iteration even needs to be carried out.

In another exemplary embodiment, it is assumed that the ALU-grid processor used in the example features intermediate registers. In this case, data can be retrieved from the corresponding rows within the ALU-grid in order to already start the decoding of additional commands during the runtime of the execution phases.

Now it becomes clear why it is not absolutely necessary to provide a branch-prediction for the ALU-grid processor: the two possible paths of a short skip can be simultaneously arranged in the ALU-grid processor with the predication-technique or it is possible to realize one path (loop element) in the ALU-grid while the other path (ensuing program code) is already arranged underneath in the ALU-grid for subsequent use. Consequently, there only remain skips over large distances that cannot be assigned to a loop and unconditional skips that, however, are already triggered in the decoding phase.

If a loop with several skip-off points (e.g., in a C-Break instruction) is executed in the ALU-grid, the decoding and configuration unit can decode commands from all possible skip destinations beforehand and intermediately store corresponding “theoretical” arrangements in an intermediate memory similar to a trace-cache. If one of the skips is executed, the calculated configuration can be very quickly loaded into the ALU-grid and the execution can be continued. The reconfiguration can be realized even faster if several configuration registers are provided in the ALU-grid and arranged in so-called planes rather than using a central intermediate memory. In this case, it is possible to use one plane for the execution while a new configuration is simultaneously written into another plane. Consequently, it is possible to directly change from one configuration to the next.

When using a trace-configuration-cache or several configuration planes, it is sensible to realize a branch-prediction of sorts. In this case, however, its function does not consist of predicting whether or not a special skip is executed, but rather of predicting the skip, with which the program presumably exits a loop. This prediction is interesting with respect to the fact which program code is decoded first and stored in the trace-cache or on another plane such that it is subsequently available when the program actually exits the loop. The longer a loop is executed, the less important this prediction becomes because an increasing number of skip-off points were decoded until the exit occurs.

1. A processor comprising at least
an arrangement of several rows of configurable execution units that can be connected into several chains of execution units by means of configurable data connections from row to row and respectively feature at least one data input and data output, with a feedback network that makes it possible to transfer a data value output at the data output of the bottom execution unit of each chain to a top-register of the chain, wherein the execution units of each chain are realized in such a way that they process data values present at the data input in accordance with their instantaneous configuration during execution phases and make available the processed data values for ensuing execution units in the chain at their data output,
a central decoding and configuration unit that autonomously selects execution units from an individual sequential command stream at runtime during several decoding phases that are separated by execution phases, generates configuration data for the selected execution units and configures the selected execution units for the execution of the commands via a configuration network,
a skip control unit that is connected to the execution units via data lines and serves for processing skip commands, and
one or more memory access units for executing memory accesses that are connected to the execution units via data lines.

2. The processor according to claim 1, characterized in that intermediate registers are arranged between all or individual rows of the arrangement, wherein said intermediate registers feature a bypass technology in order to loop through data values, if so required, without the storage thereof.

3. The processor according to claim 1, characterized in that data outputs and data inputs of several execution units of each chain and/or, if applicable, existing intermediate registers are connected to the feedback network in order to feed back data values obtained at a lower location of the chain to an upper location of the chain.

4. The processor according to claim 1, characterized in that the execution units of each row are connected to one another via a row routing network, wherein one or more memory access units are assigned to each row by the row routing network.

5. The processor according to claim 1, characterized in that the execution units feature predication inputs that are connected to the skip control unit, wherein said predication inputs enable the skip control unit to control whether the commands are actually executed in the respective execution units during the execution phases.

6. The processor according to claim 1, characterized in that a few of the execution units can be assigned to several chains.

7. The processor according to claim 6, characterized in that at least some of the execution units that can be assigned to several chains consist of execution units designed for special functions.

8. The processor according to claim 1, characterized in that a few or all rows feature a virtual execution unit that provides all required connections for the data input and the data output and can be connected to one or more central special execution units, wherein the virtual execution unit only serves for allowing the special execution unit to process the data values present at its data input and for making available the processed data value at its data output.

9. The processor according to claim 8, characterized in that virtual execution units of several rows are connected to an arbiter that controls the access to the one or more central special execution units.

10. The processor according to claim 1, characterized in that the processor features an energy saving mechanism that switches off the decoding and configuration unit and/or unneeded rows of the arrangement during the execution phase.

11. The processor according to claim 1, characterized in that the memory access units feature streaming-buffers.

12. The processor according to claim 1, characterized in that a central intermediate memory is provided for configuration data and/or each execution unit features several configuration registers for configuration data and the decoding and configuration unit is realized in such a way that it already decodes further commands of the sequential command stream beforehand during the execution phases and stores the corresponding configuration in the intermediate memory or in configuration registers that are not used for the instantaneous configuration in order to quickly make available the next configuration when it is needed.

13. The processor according to claim 12, characterized in that the decoding and configuration unit is realized such that, when executing a program loop with several possible skip destinations, it decodes commands of the possible skip destinations beforehand during the execution phase of the program loop and stores the corresponding configuration in the intermediate memory or in configuration registers that are not used for the instantaneous configuration in order to quickly make available the next configuration when it is needed.

14. The processor according to claim 1, characterized in that means are provided for using tokens in the chains of the arrangement for synchronization purposes.
